(19) United States
(12) Patent Application Publication
(10) Pub. No.: US 2005/0126133 A1
(43) Pub. Date: Jun. 16, 2005

(54) Training aid for a large domestic animal

(76) Inventor: Ted L. Blocker, Estacada, OR (US)

Correspondence Address: KOLISCH HARTWELL, P.C., 520 S.W. YAMHILL STREET, SUITE 200, PORTLAND, OR, 97204, US

(21) Appl. No.: 11/013,566

(22) Filed: Dec. 15, 2004

Related U.S. Application Data
(60) Provisional application No. 60/530,468, filed on Dec. 16, 2003.

(51) Int. Cl. B68B 1/00

(52) U.S. Cl. 54/71

(57) ABSTRACT

A training device for use in training large domestic animals is disclosed, wherein the training device includes a shaft having a first end and a second end, wherein the first end is configured to accept attachment of a training aid, and a handle extending from the second end of the shaft, wherein the handle is configured to be placed over an object to suspend the training device from the object.

### CROSS-REFERENCE TO RELATED APPLICATIONS

This application claims priority to U.S. Provisional patent application Ser. No. 60/530,468, filed Dec. 16, 2003, the disclosure of which is hereby incorporated by reference.

### BACKGROUND

Various training aids may be used in the process of training a large domestic animal, such as a horse, to respond to voice commands, to be desensitized to sharp and/or loud noises, etc. One type of training device includes a rigid or semi-rigid shaft having a length of a few feet, a handle or grip disposed on one end of the shaft, and a short length of a flexible material, such as a leather strap, attached to the opposite end of the shaft as the grip. The handle has a straight configuration with no bends, much like a golf club grip.

When training a horse with such a training device, a trainer typically stands near the horse while holding the horse by a lead line. The lead line is held in one hand, and the training device in the other. The trainer then gives a verbal command to the horse, such as “forward,” and gently taps the horse with the training device to get the horse to move in a desired direction. However, lead lines are relatively short, and after several feet of movement in one direction, the trainer will have the horse change directions and walk the other direction.

Once the horse changes direction, the training device and the lead line may each be in the wrong hand for easiest use. Therefore, the trainer must exchange the rope and training device between hands. It is important that the trainer not drop the lead line during a training session. However, when exchanging the lead line and the training device between hands, the trainer generally must hold both the lead line and the training device in a single hand at some point during the exchange process. Thus, there is a risk that the trainer may drop either the lead line or the training device during the exchange. The risk may be especially high if the horse makes a sudden and/or unexpected movement during the exchange process. Furthermore, if either the lead line or the training device is dropped during the exchange process, the trainer may have to bend down to pick up the dropped item. This may expose the trainer's hand, arm and/or head to kicks, etc. from the horse, and also removes the trainer's eye from the horse for a period of time.

Instead of holding the lead line and the training device in the same hand while exchanging the items between hands, the trainer may prop the training device against a wall, fence, the trainer's body, or other object during the exchange. However, due to the straight configuration the handle, the training device may not remain in a stable position against the object, but instead may roll or slide along the object and fall onto the ground.

### SUMMARY

One embodiment provides a training device for use in training large domestic animals, wherein the training device includes a shaft having a first end and a second end, wherein the first end is configured to accept attachment of a training aid, and a handle extending from the second end of the shaft, wherein the handle is configured to be placed over an object to suspend the training device from the object.

Another embodiment provides a training device for use in training large domestic animals, wherein the training device includes a shaft having a first end and a second end, a training aid coupled with the first end of the shaft, and a nonlinear handle extending from the second end of the shaft.

Yet another embodiment provides a training device for use in training large domestic animals, wherein the training device includes a shaft having a first end and a second end, a flexible member coupled with the first end of the shaft, and a grip coupled with the second end of the shaft, wherein the grip has at least one of a bent configuration and a curved configuration.

### BRIEF DESCRIPTION OF THE FIGURES

FIG. 1 shows a first exemplary embodiment of a training device.

FIG. 2 shows an embodiment of a training aid attachable to the training device embodiment of FIG. 1.

FIG. 3 shows the embodiment of FIG. 1 in a user's hand.

FIG. 4 shows the embodiment of FIG. 1 suspended from the user's hand upon being released from the user's hand.

FIG. 5 shows the embodiment of FIG. 1 suspended from the user's wrist in dashed lines, and shows the user's hand reaching downwardly to grasp the shaft of the training device in solid lines.

FIG. 6 shows the user's hand reaching downwardly to grasp the shaft of the embodiment of FIG. 1.

FIG. 7 shows the user grasping the shaft of the training device.

FIG. 8 shows another embodiment of a training device.

### DETAILED DESCRIPTION OF THE DEPICTED EMBODIMENTS

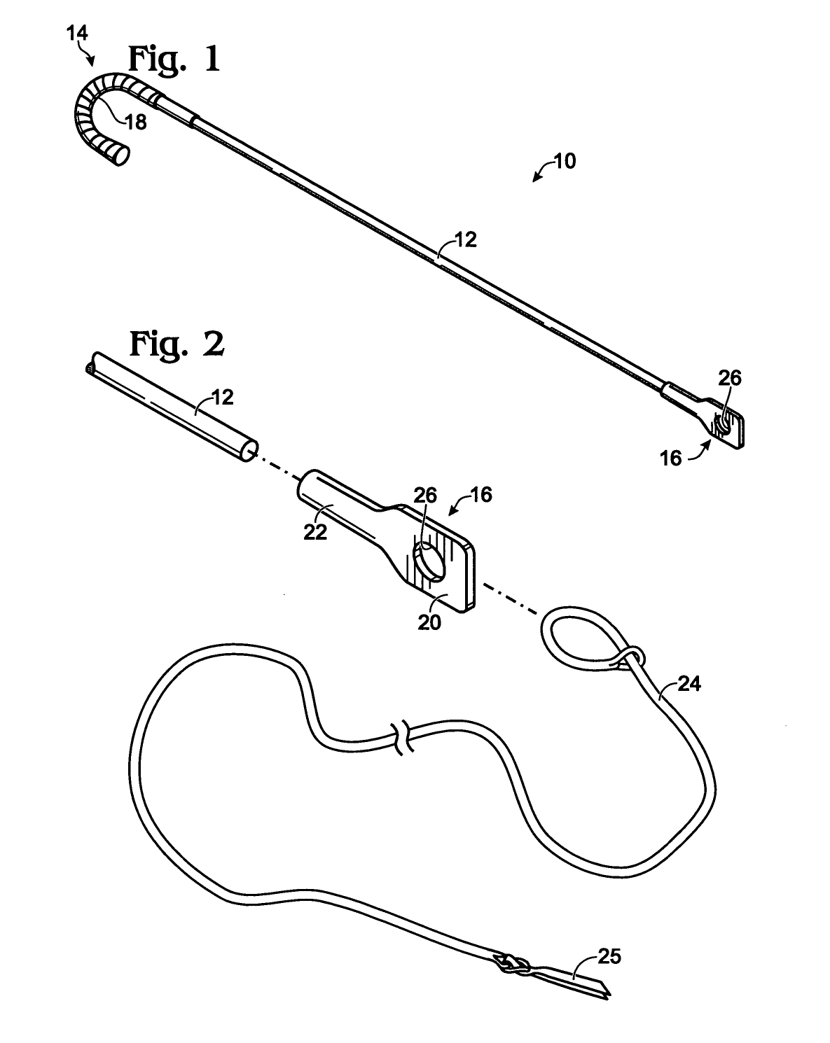

FIG. 1 shows, generally at 10, a training device for large domestic animals, including but not limited to, horses, mules, donkeys, and other such animals. Training device 10 includes a shaft 12, a handle or grip 14 disposed at one end of the shaft, and may include a desired training aid (for example, a length of rope, small leather strap or rubber/polymer member, etc.) disposed at the opposite end of the shaft as the grip. Unlike prior training devices, which have linear handles (i.e. that do not deviate from the long axis of the shaft), handle 14 of training device 10 includes a curved or bent (i.e. non-linear) portion 18. Curved portion 18 allows training device 10 to be hung over an arm when changing a lead line from one hand to another, thus alleviating the problems associated with simultaneously changing prior training devices and lead lines between hands. Furthermore, curved portion 18 may be securely hooked over a fence, corral panel, or any other suitable structure. Curved portion 18 further provides a more stable contact point for leaning training device 10 against a wall or other object, and may help to prevent the training device from falling down when it is propped against an object. Furthermore, when hung over a user's arm, training device 10 may be quickly and simply re-grasped with either hand.

Training device 10 offers several advantages over prior training devices. For example, training device 10 may be used to drive a dangerous and disrespectful horse out and away from a handler, and to keep the horse at a safe distance while working on a lead line and/or in a round pin. End 16 of training device 10 may also be used to urge the horse to change directions in such an environment, thus gaining control and respect through these exercises. Curved portion 18 of handle 14 allows the handler to keep training device 10 securely attached over the trainer's arm (or over a nearby fence, corral panel, etc.), as described in more detail below, during these dangerous activities, and therefore greatly increases the safety of the handler.

Training device 10 may also be used to train a horse that does not want its feet handled. A user of training device 10 may first desensitize the horse to having its feet touched by touching the horse's feet with the training device. Training device 10 acts as an extension of the arm of the user, allowing the user to touch the horse's feet while to keeping head, hands and other vulnerable body parts well away from the horse's feet. The user can repeat this exercise until the horse doesn't mind having its feet touched. Then, the user may use curved portion 18 of handle 14 to pick up the horse's feet, and repeat until this no longer upsets the horse. Thus, training aid 10 allows the user to train the horse to have its feet picked up while remaining at a safe distance until the user feels it is safe to handle the horse's feet by hand.

Furthermore, training aid 10 may aid in attaching a saddle to a horse. When saddling a young horse for first few times, it can be dangerous to reach beneath the horse to grab the loose end of a cinch. This is because the motion places the user's head and upper body in a very vulnerable position in close proximity to horse's hind feet, where the user may get kicked. Curved portion 18 of training device 10 may be used to reach under a horse to get cinch, thereby keeping the user in a safe position.

Curved portion 18 of handle 14 may have any desired configuration. For example, the curvature of curved portion 18 may be smooth and continuous, as depicted, or may have one or more angular bends along its length. Furthermore, curved portion 18 may have both angular bends and smoothly curving portions. Likewise, curved portion 18 may curve any desired degree from the long axis of shaft 12. It may be desirable for curved portion 18 to have sufficient curvature and length to stay securely on the user's arm without requiring any effort by the user to prevent it from falling off. Handles that bend or curve at least ninety degrees away from the long axis of shaft 12 may be easier to retain over a user's arm than handles that bend or curve less than ninety degrees. In the depicted embodiment, curved portion 18 bends approximately one hundred eighty degrees from the long axis of the shaft, and extends sufficiently far to prevent the end of curved portion 18 from working its way over the user's arm when the training device is hanging from the user's arm. However, it will be appreciated that this configuration is merely exemplary, and that curved portion 18 may have any other suitable degree of curvature. Curved portion 18 may optionally be formed from, or partially or fully covered with, a non-slip material and/or a padded material.

FIG. 2 shows an exemplary embodiment of training aid 16 in more detail. Training aid 16 is configured to be attached to an end of shaft 12, and to provide a soft, pliant surface suitable for tapping an animal in a desired direction during training. The depicted training aid 16 includes a flexible end 20 for tapping the animal, and a connector, such as a cap 22 or sleeve, for connecting training aid 16 to the end of shaft 12. Cap 22 has an inner diameter sized to fit snugly on the end of shaft 12. An adhesive or fastener may be used to attach cap 22 to the end of shaft 12 more securely, if desired. In the depicted embodiment, cap 22 and flexible end 20 are unitary. This may allow training aid 16 to be constructed of a plastic or polymer material via a simple injection molding process. However, cap 22 and flexible end 20 may be formed from separate pieces if desired. Furthermore, flexible end 20 may be attached to shaft 12 by any suitable mechanism other than cap 22.

Training aid 16 may be configured to accept the attachment of an additional training aid. Examples of additional training aids include, but are not limited to, ropes, straps, and cords, as depicted at 24. In the depicted embodiment, flexible end 20 of training aid 16 includes an opening 26 configured to accept insertion of a rope, cord or other like object. However, flexible end 20 may include any other suitable feature for attaching additional training aids.

Additional training aids may be attached to training aid 16 for a variety of uses. For example, length of rope 24 may be attached to training aid 16 to form a simple tool for desensitizing a horse to loud and/or sudden noises. A user may snap rope 24 against the ground in the vicinity of the horse to create a sudden, sharp sound while holding the horse's lead line (and an appropriate tip 25 may be provided to make the sound louder and/or sharper). If the horse panics at the sound, the user may quickly hang the training tool over an arm and use the free hand to control and/or soothe the horse, to get a firmer two-handed grip on the lead line, etc. Training device 10 may likewise be quickly grasped once the situation is under control without the user having to bend down to pick the training device off the ground. Thus, the user does not expose head, arms, hands, etc. to dangerous kicks from the horse when re-grasping the training device.

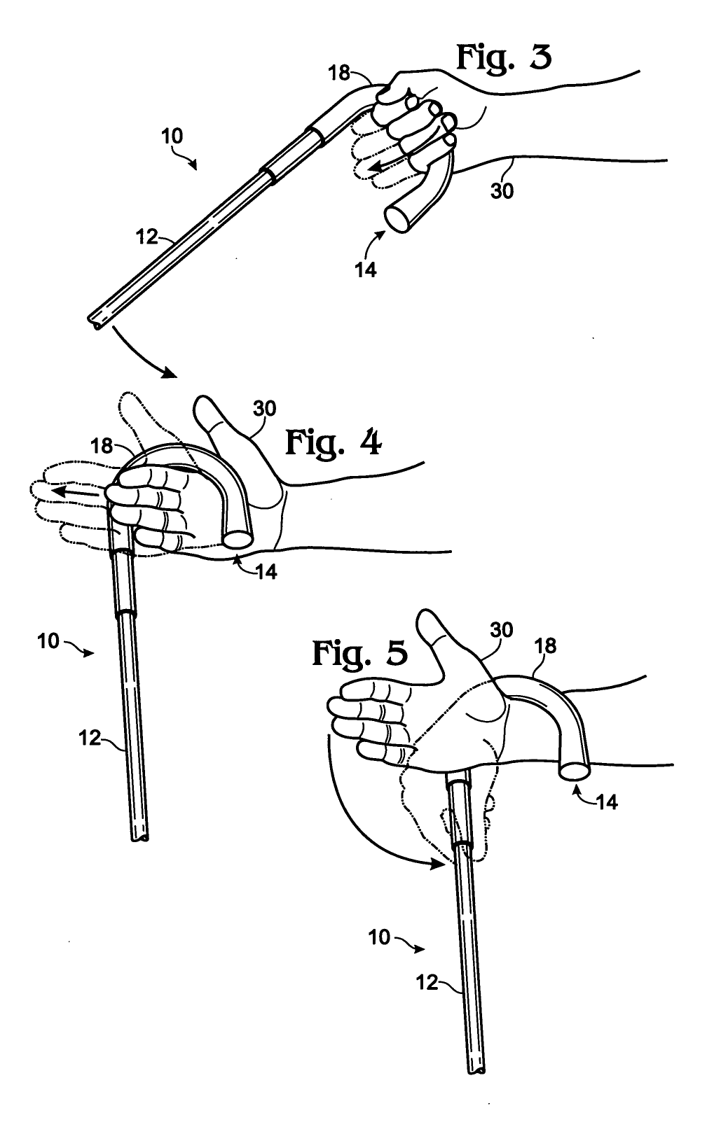

As mentioned above, a user may easily transfer a training device 10 gripped in the user's hand to a hanging position on a wrist or forearm on the same side of the body, without the user having to use the other hand. FIGS. 3-7 illustrate an exemplary sequence of motions for transferring the training device from a hand to a hanging position on a forearm, and then back to the same hand. First, FIG. 3 shows training device 10 being gripped in a user's hand 30. Training device 10 is depicted as being gripped on curved portion 18 of handle 14, but the user may also grip training device 10 at a location along shaft 12. FIG. 3 also shows, in dashed lines, the user beginning to open the hand 30. This allows training device 10 to slide through or pivot on the user's hand 30 until reaching a stable position on curved portion 18. Upon reaching the stable position on curved portion 18, training device 10 simply hangs from the user's hand 30, as shown in FIG. 4. If desired, the user can then tuck the thumb below handle 14 and work the training device to a position on the forearm, as shown in FIG. 5, by appropriate wrist and arm motions. At this point, the user is free to use hand 30 for other tasks, yet training device is securely positioned on the user's arm where it can be accessed immediately if needed.

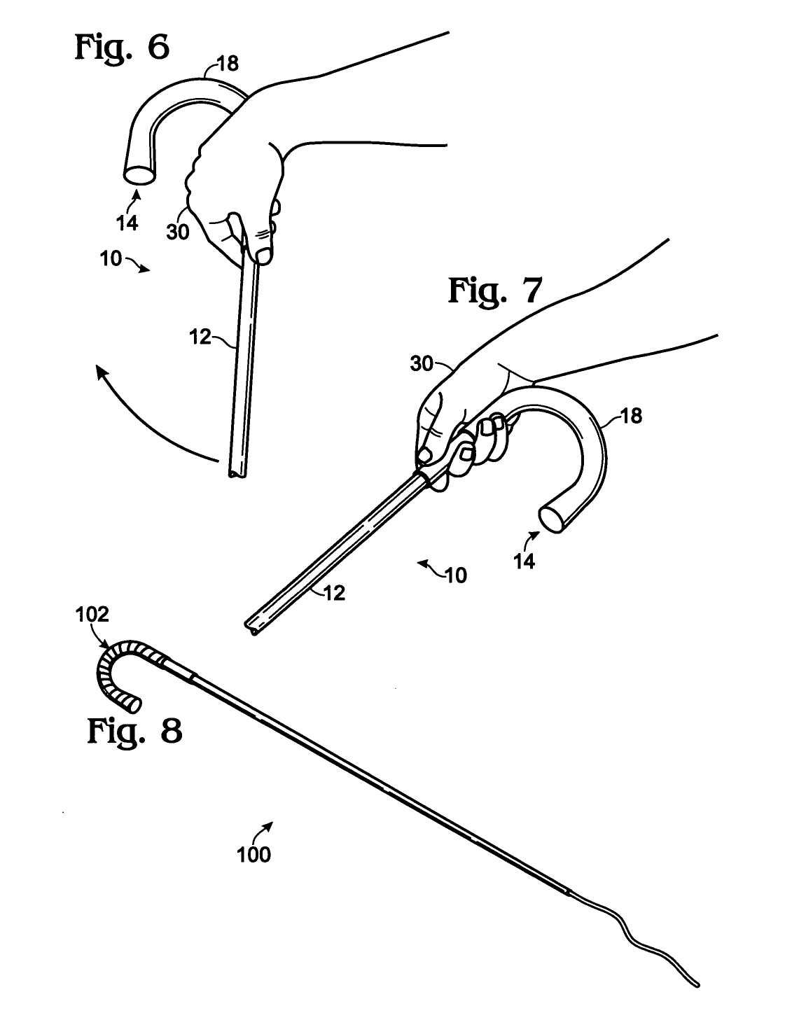

FIGS. 5-7 illustrate an exemplary sequence of movements for transferring training device 10 from the user's arm back to the user's hand. First referring to FIG. 5, the user can reach down with hand 30 and grasp shaft 12 of training device 10 while the training device is hanging over the over the user's arm. Next, the user can move wrist and forearm beneath handle 14, as shown in FIG. 6. This places training device 10 fully in the user's hand, ready for use, as shown in FIG. 7. Training device 10 likewise may be grasped just as quickly with the other hand.

Curved portion 18 of handle 14 also allows training device 10 to be hung over a user's arm while riding a horse, and thus may allow the user to grasp the reigns more securely without risking dropping the training device. In this case, the user may quickly grasp the training device with either hand, should the need arise while riding.

The principles described herein may also be extended to other tools similar to training device 10. For example, FIG. 8 shows a dressage whip 100 having a curved handle 102. Like training device 10, whip 100 may be hung over a user's arm while riding a horse, or while on the ground working with a horse, and may be quickly re-grasped as described above.

Although the present disclosure includes specific embodiments of training devices for large animals, specific embodiments are not to be considered in a limiting sense, because numerous variations are possible. The subject matter of the present disclosure includes all novel and nonobvious combinations and subcombinations of the various elements, features, functions, and/or properties disclosed herein. The description and examples contained herein are not intended to limit the scope of the invention, but are included for illustration purposes only. It is to be understood that other embodiments of the invention can be developed and fall within the spirit and scope of the invention and claims.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A training device for use in training large domestic animals, the training device comprising:
a shaft having a first end and a second end, wherein the first end is configured to accept attachment of a training aid; and
a handle extending from the second end of the shaft, wherein the handle is configured to be placed over an object to suspend the training device from the object.

2. The training device of claim 1, wherein the training aid includes at least one of a length of rope, a cord and a strap.

3. The training device of claim 1, wherein the handle includes a generally smoothly curved portion.

4. The training device of claim 1, wherein the handle includes a bent portion.

5. The training device of claim 1, wherein the handle curves or bends at least 90 degrees from a long axis of the shaft.

6. The training device of claim 1, wherein the training aid is a flexible member extending from the second end of the shaft.

7. The training device of claim 6, wherein the flexible member is made of a polymer material.

8. The training device of claim 6, wherein the flexible member is made of leather.

9. The training device of claim 6, wherein the flexible member includes a feature configured to accept attachment of at least one of a rope, a cord and a strap.

10. The training device of claim 6, wherein the training aid includes a cap coupled With the flexible member, wherein the cap is configured to fit over the first end of the shaft.

11. A training device for use in training large domestic animals, comprising:
a shaft having a first end and a second end;
a training aid coupled with the first end of the shaft; and
a nonlinear handle extending from the second end of the shaft.

12. The training device of claim 11, wherein the nonlinear handle is smoothly curving.

13. The training device of claim 11, wherein the nonlinear handle is bent.

14. The training device of claim 11, wherein the nonlinear handle bends or curves at least ninety degrees from a long axis of the shaft.

15. The training device of claim 11, wherein the training aid includes a cap configured to fit over the second end of the shaft, and a flexible member extending from the cap.

16. The training device of claim 15, wherein the flexible member includes an opening configured to accept attachment of an additional training aid.

17. The training device of claim 16, wherein the additional training aid is selected from the group consisting of ropes, cords and straps.

18. The training device of claim 15, wherein the cap and the flexible member are unitary.

19. The training device of claim 15, wherein the flexible member is made at least partially of a polymer material.

20. A training device for use in training large domestic animals, comprising:
a shaft having a first end and a second end;
a flexible member coupled with the first end of the shaft; and
a grip coupled with the second end of the shaft, wherein the grip has at least one of a bent configuration and a curved configuration.

21. The training device of claim 20, wherein the grip includes a portion bent or curved at least ninety degrees from a long axis of the shaft.

22. The training device of claim 20, wherein the grip is configured to be hooked over an arm.

23. The training device of claim 20, wherein the flexible member includes an opening configured to accept attachment of an additional training aid.

24. The training device of claim 20, wherein the flexible member includes a cap configured to fit over the first end of the shaft.
